(19) United States
(12) Patent Application Publication
(10) Pub. No.: US 2026/0167304 A1
(43) Pub. Date: Jun. 18, 2026

(54) FOLDABLE CRADLE FOR BOAT

(71) Applicant: Kalmar Produktutveckling AB, Vassmolösa (SE)

(72) Inventor: Ulf Bengt Mattias Rickardsson, Vassmolösa (SE)

(21) Appl. No.: 18/864,931

(22) PCT Filed: May 22, 2023
(86) PCT No.: PCT/SE2023/050500

§ 371 Date: Nov. 12, 2024

(30) Foreign Application Priority Data
May 21, 2022 (SE) 2230158-4

(51) Int. Cl. B63B 23/62

(52) U.S. Cl. CPC B63B 23/62

(57) ABSTRACT

Many boats carry a tender like a jet ski or similar. Where the tender is placed on the boat there are tender chocks, also called boat cradle, that fits the tender. There are many types of tender chocks but they all have in common that they are in the way and takes valuable space when not in use.

This invention refers to foldable tender chocks intended to support a tender. The tender chocks folds down when not needed in the construction it is mounted in. When it is folded down in the construction it enables to use the space for placing objects and it is not in the way for people.

Many boats carry an extra boat such as a jet ski, jet ski, rib boat or inflatable boat in lakes and seas. There are several ways to transport the extra boat, for example by towing it behind the boat or placing it on the boat. There are several ways to place the extra boat on the boat. For example, by winching it onto the boat, lifting it onto the boat with a crane, lifting it onto the boat with a passerelle. There are also examples where the boat lowers a part of the boat, for example a part or a whole swim platform below the surface of the water whereby the extra boat can float over this part where the part is then lifted up again and the extra boat is then placed on the boat.

Where the extra boat is placed on the boat, some type of cradle is placed that fits the hull of the extra boat. There are many different types of cradles, but the common thing is that they are there and take up space even when they are not in use. This means that the surface becomes limited in use when it is not used to place an extra boat.

The solution to the limited use of the surface has been solved by making the cradle foldable, compact, low construction height and possible to install on all boats. The cradle is also designed in such a way that a locked, fixed angle can be adjusted to fit the hull of the extra boat.

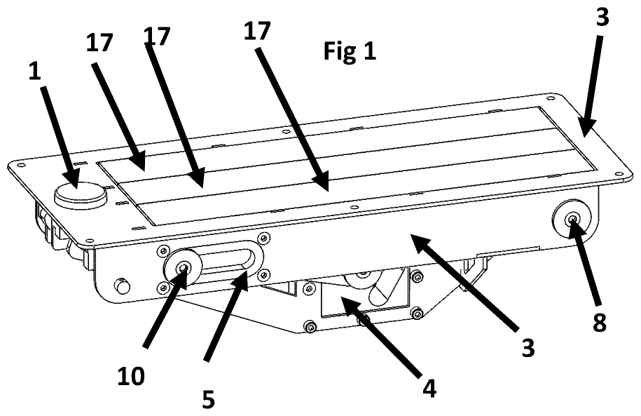

FIG. 1 shows the foldable cradle in the folded-down position seen in perspective view from the top.

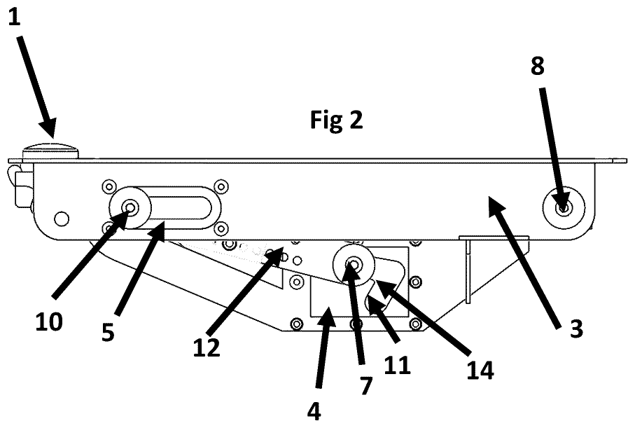

FIG. 2 shows the foldable cradle in the folded-down position seen from the side perpendicular to the extra boat's direction of travel.

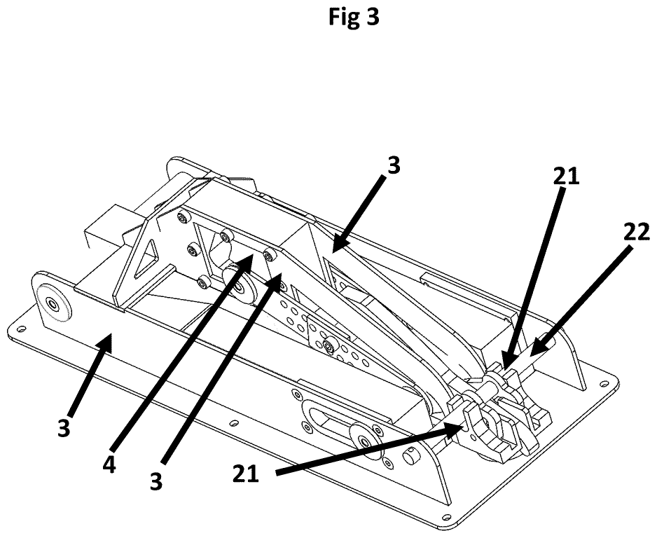

FIG. 3 shows the foldable cradle in the folded-down position seen in a perspective view of the underside.

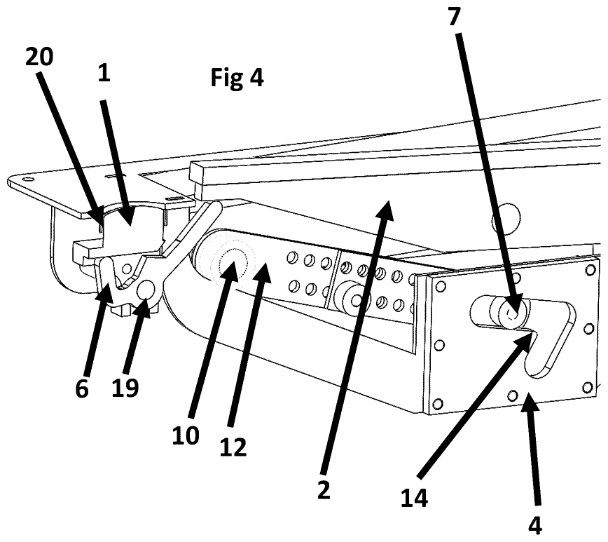

FIG. 4 shows a sectional view through the foldable cradle in the near folded-down position where button (1) presses on the lifting yoke (6) which presses on cradlewall (2).

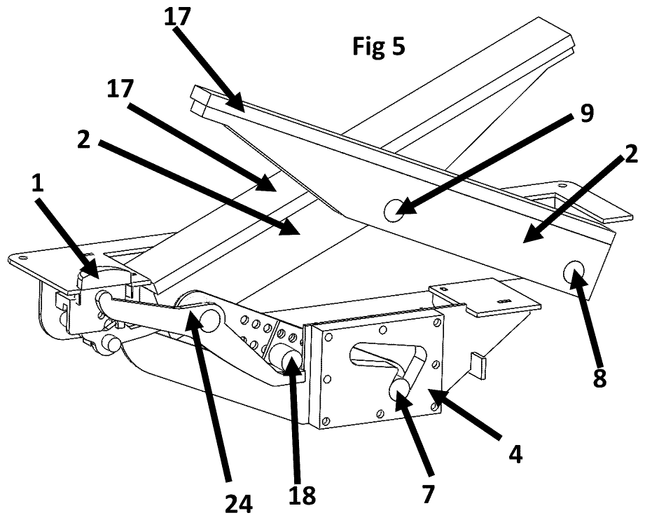

FIG. 5 shows a sectional view through a foldable cradle in a cradle in the folded-up position seen in perspective view top side.

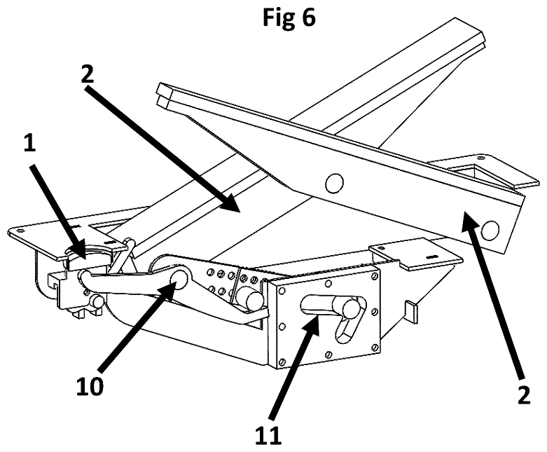

FIG. 6 shows a sectional view through a foldable cradle in a cradle in the folded-up position seen in perspective view top side.

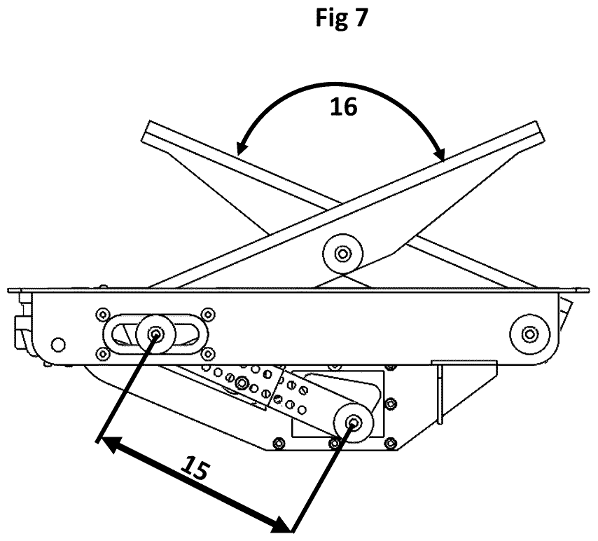

FIG. 7 shows the foldable cradle in the cradle in the folded-up position seen from the side perpendicular to the extra boat's direction of travel.

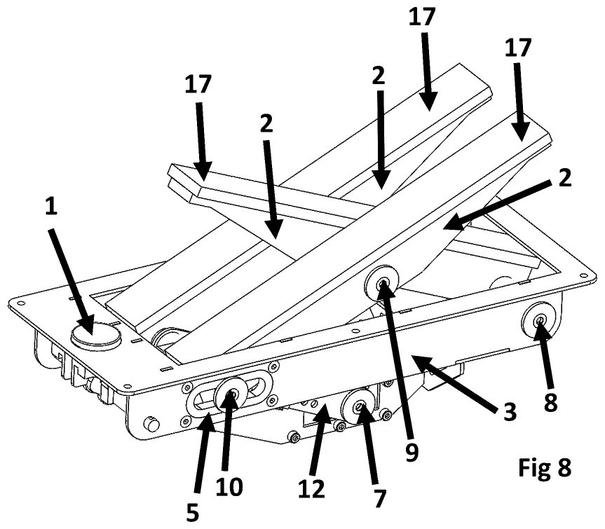

FIG. 8 shows the foldable cradle in the folded-down position seen in perspective view top side.

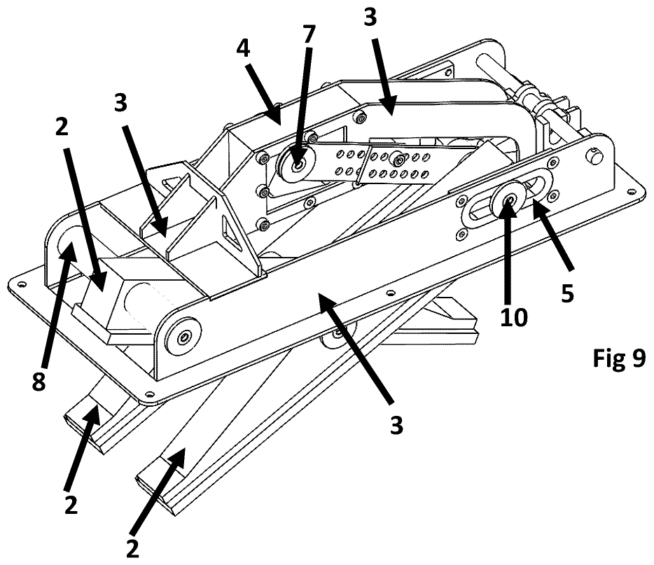

FIG. 9 shows the foldable cradle in the folded-up position seen in perspective view top side.

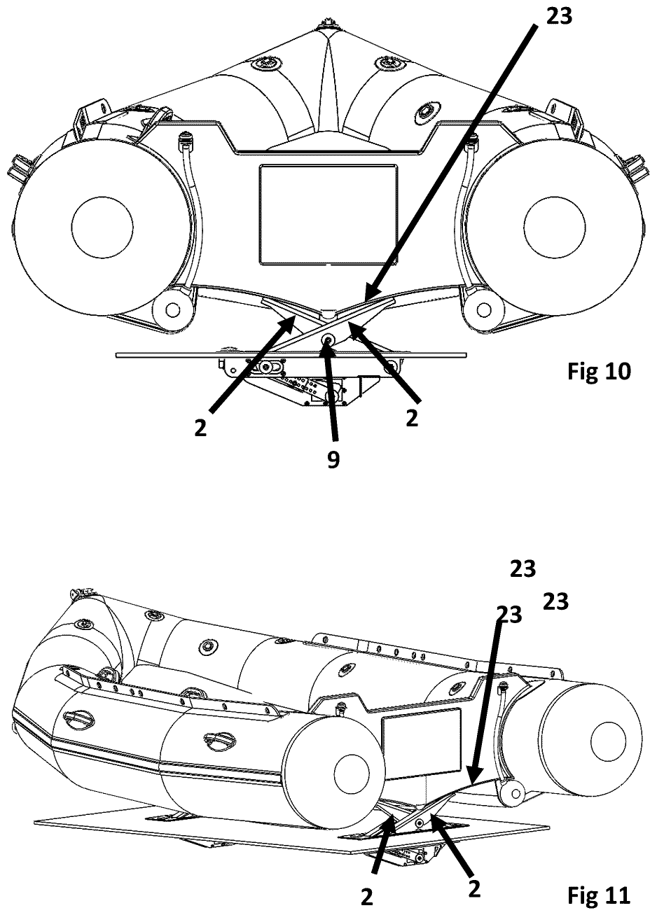

FIG. 10 shows the foldable cradle in the folded-up position seen in perspective view of the underside.

FIG. 11 shows the foldable cradle in the folded-up position with the extra boat between the sides of the cradlewalls (2) seen perpendicular to the direction of travel of the extra boat.

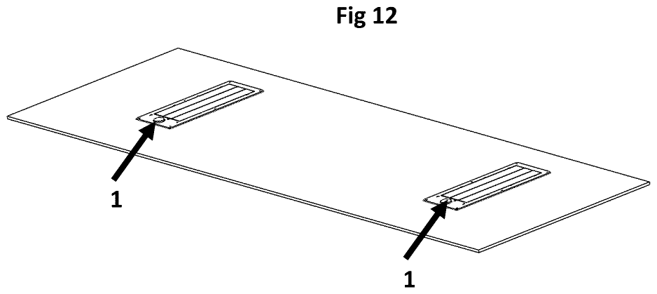

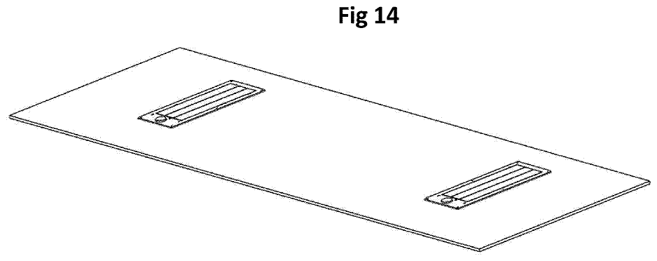

FIG. 12 shows the foldable cradle in the folded-up position with an extra boat between the cradlewalls (2) seen in perspective top view.

FIG. 14 shows 2 foldable cradle in the folded-down position mounted on a boat seen in perspective top view.

This invention consists of the below-described frame construction (3) which holds cradlewalls (2) in place through a shaft (8), and second shaft (9) and a sliding shaft (10). When the button (1) is pressed down, it presses on the lifting yoke (6) stored in the yoke shaft (19) which in turn presses on one cradlewall (2), causing all cradlewalls (2) to be pushed up. Since cradlewalls (2) are assembled using second shaft (9), all cradlewalls (2) are lifted up. In this raised position, cradlewalls (2) can be lifted up manually in what is called a “lifting sequence”. By adjusting the distance (15) on the stay (12), the angle (16) changes to fit different extra boats. Cradlewalls (2) are coated with a wear surface (17) which is replaceable. This surface can, for example, be teak, plastic or similar.

The button (1) sits in a slide tube (20) which allows the button (1) to slide up and down in the slide tube (20). The button (1) has a guided opening (21) on the underside that allows the button (1) to be guided over the shaft (22) so that the drawer lock effect does not occur when the button (1) is pressed.

The cradle is mounted into the boat's construction so that the wear surface (17) is at the same height as the existing boat's surface construction. FIG. 14 shows 2 foldable cradles, assembled.

### Up-Folding Sequence

During the lifting sequence, the sliding shaft (10) which is stored in some cradlewalls (2) is moved in the track (5) at the same time that the lock shaft (7) firmly connected to the stay (12) stored in the sliding shaft (10) slides in the lock block (4). When the lock shaft (7) has passed the edge (14), the lock shaft (7) goes down into the bottom of the lock block (4) due to its locking path (11). In this position, cradlewalls (2) are completely locked due to lock shaft (7) position in the lock block (4). In this up-folded position, the foldable cradle is used as support for an extra boat.

### Down-Folding Sequence

During the lowering sequence, button (1) is pressed down, which presses on the lowering yoke (24), which in turn presses on the stayshaft (18) which is firmly connected to the stay (12). When button (1) has been pressed down so much that lock shaft (7) has passed edge (14), cradlewalls (2) fall down to the down-folded position

1. Foldable cradle for extra boat characterized by at least two cradlewalls (2) where the hull (23) of the extra boat is placed between the cradlewalls (2) where at least one is stored in a shaft (8) where all the cradlewalls (2) are stored in an second shaft (9) and those that are not stored in the shaft (8) are stored in a sliding shaft (10) that slides through a track (5).

2. Foldable cradle for extra boat according to claim 1, characterized in that at least one strut (12) is stored in the sliding shaft (10) at one end and at the other end the stay (12) is connected to a lock shaft (7) which is moved in a lock block (4) which, through its design, locks the lock shaft (7) in a locking path (11) in the lock block (4).

3. Foldable cradle for extra boat according to claim 1, characterized by a button (1) pressing a lifting yoke (6) which in turn presses on a cradle wall (2), causing all the cradlewalls (2) to be pushed up in order to be able to lift the cradlewalls (2) manually.

4. Foldable cradle for extra boat according to claim 1, characterized in that a button (1) presses on a lowering yoke (24) which in turn presses on the stayshaft (18) which is firmly connected to the stay (12). When the button (1) has been pressed down so much that the lock shaft (7) has passed edge (14), the cradlewalls (2) fall down into position.

5. Foldable cradle for extra boat according to claim 1, characterized in that the cradlewalls (2) are coated with a replaceable wear surface (17).
